(19) United States
(12) Patent Application Publication
(10) Pub. No.: US 2008/0104040 A1
(43) Pub. Date: May 1, 2008

(54) VISUALLY INTUITIVE SEARCH METHOD

(76) Inventor: Krishnamsetty Chiranjivi Ramakrishna, Hyderabad (IN)

Correspondence Address: LOUIS VENTRE, JR, 2483 OAKTON HILLS DRIVE, OAKTON, VA, 22124-1530, US

(21) Appl. No.: 11/968,719

(22) Filed: Jan. 3, 2008

(30) Foreign Application Priority Data
Sep. 26, 2007 (IN) 2160/CHE/2007

(51) Int. Cl. G06F 17/30

(52) U.S. Cl. 707/3

(57) ABSTRACT

A method and system for re-arranging the search results based on user-defined attributes for various search objects is disclosed. In one or more embodiments, the system and method for re-arranging search results according to user stylized search terms. The user can stylize the search terms in various ways so as to give a search term priority over another.

### CROSS-REFERENCE TO RELATED APPLICATIONS

The present invention claims the benefit of the filing date of India application 2160/CHE/2007 filed 26 Sep. 2007, the entire disclosure of which is incorporated by reference herein.

### FIELD OF INVENTION

The invention relates to a visually intuitive search method. In particular, the present invention relates to a method and a system for providing a user-interface allowing a user to prioritize the search results based on user preference.

### BACKGROUND OF THE INVENTION

In the contemporary times, terabytes of information is being added, uploaded, shared and sent across the world over the internet every day. To find a particular document of interest (or a file, directory, music, video or any other information) in the huge ocean of information, search engines have come to play a very important role.

Search engines are essentially software programs which search databases, collect and display information related to search terms specified by a user. Thus, search engines are information retrieval systems designed to help find information stored in a computer system, inside a corporate or proprietary network, or on the World Wide Web.

A typical search engine allows a user to search for any content, through an interface where the user typically enters a search term or a string of search terms (to be searched) in a textbox provided in the interface. Search engine then searches for the search term in databases on the computer system or the network using different algorithms. The search engine then presents a list of search results to the user, which is often sorted with respect to some measure of relevance of the results.

Various attempts have been made to increase the relevancy of the search results for the user and make the search interface more user-friendly. For example, U.S. Pat. No. 5,982,370 discloses a highlighting tool for specifying a search term on the computer interface by highlighting it. Here the user can highlight a particular word or phrase in a displayed text document on the computer interface using a highlighting tool. Highlighting a word triggers an application program, and the user-interface presents the user with an option for searching the word. Thus, any word which is highlighted by the user is taken as an input for the search engine. However, here the users can only search for those words or phrases which are present in the text document.

U.S. Pat. No. 6,012,053 discloses a system for performing searches on a collection of information where the system assigns weights to search results based on relevance factors given by the user. Here, the relevance factors are specified for the search query and not for individual search terms in the search query. Various relevance factors are used like frequency of the words, words appearing in title and in text, words appearing in exact order etc. which can be specified individually by the user in the user-interface. The search results are ordered based on the weights specified by the user.

Some search engines like QUINTURA, offer a visual-based search engine for discovery and browsing of any web content including images, videos and products. QUINTURA search displays an interactive search cloud (as graphical icons) of related keywords and phrases, to narrow down searches. Here, as one scrolls over the icons which are displayed in one half of the computer screen, the results are dynamically displayed in the other half of the screen. However, this search engine suffers from some drawbacks. Firstly, the search terms in a search query cannot be prioritized individually based on the preference of users. As a user scrolls over an icon, he is presented with various icons to choose from. This again becomes cumbersome as one cannot exactly search for specific search terms. Further, since displayed icons present only a limited number of related choices, often the user has to manually enter the other keywords to narrow down the searches.

Texas Instruments offers a search engine for searching its own database for product/process change notification where the user can set individual importance to each of the search term. Here if the database being searched has a full text index, then the user can use an operator, here known as a ‘Termweight’ operator to change the relevance ranking of the search terms, thus increasing or decreasing the importance of a particular search term in the search. As a result, the search results are sorted such that the search results that are relevant to the most important search terms figure at the top of the list of the search results. However, this search engine has the limitation that it is cumbersome for a user to provide termweights for each of the search terms and this also makes the search query unnecessarily long.

The existing search engines and the search methodologies have the limitation that they focus more on optimizing the retrieval time and search engine defined relevance of the results rather than on the relevance as needed by the user of the search engine.

Hence, there is a need for a system for making search interface visually intuitive. Further, there is a need for a user-friendly search interface for conducting a search with different priorities assigned to different search terms to have more relevant search results.

### BRIEF SUMMARY OF THE INVENTION

An object of the invention is to provide a user-interface to a search engine, where a user can intuitively prioritize her search results. The present invention provides a mechanism through which results from a search query are re-arranged according to user stylized search terms. The user can stylize the search terms in various ways so as to give a search term priority over another. Different styles like boldfacing a word or increasing the font of a word etc. is given a weight-factor. These weight-factors are combined for all search terms individually for each search result to get a final score of the weights. The scores of the search result control the presentation of search results. The invention also allows a user to vary the degree of priority of different terms within a query string by varying the fonts and background color of the search terms.

### BRIEF DESCRIPTION OF THE DRAWINGS

The various embodiments of the invention will hereinafter be described in conjunction with the appended drawings provided to illustrate and not to limit the invention, wherein like designations denote like elements, and in which:

FIG. 1 is a schematic diagram illustrating the system elements, according to an embodiment of the invention.

FIG. 2 is a schematic diagram representing the post-processor, according to an embodiment of the invention.

FIGS. 3A and 3B is a flowchart representing the process of re-organizing the searched results, according to an embodiment of the invention.

FIGS. 4A and 4B illustrate the methodology for determining the scores of search results.

FIG. 5 illustrates an example user-interface through which a user may input search query.

FIG. 6 illustrates a presentation of the list of searched items, according to an embodiment of the invention.

### DETAILED DESCRIPTION

In the present invention, a method and a system for organizing search results in a user-defined order have been disclosed. The method comprises integrating a user-interface with a search engine, wherein the search results returned by the search engine for a given search query are organized based on the preferences given by a user.

The user-interface can also take other search objects as the search query and is not limited only to text search. Other media inputs apart from text can be an image, hologram, audio clip or video clip. The search query could be a text where two or more search terms have been stylized in different styles, an image where different portions of the image have been highlighted in different shades or colors or even a video clip where different portions of the clip have been tagged with different attributes. Thus the stylized search terms, the highlighted portions of an image, tagged video clips are different search objects that are used for prioritizing the search results. Each of the different attributes—styles in case of a text query, color shades in case of an image search or tags in case of a video clip search are assigned weights from a predefined list of weights. The search query is submitted to a search engine which searches the database linked to the search engine. The search results returned by the search engine for the search query are stored in a score-determining module. These search results are then assigned scores based on various weights of search terms, from the predefined list of weights. The search results are then displayed to the user in descending order of the scores.

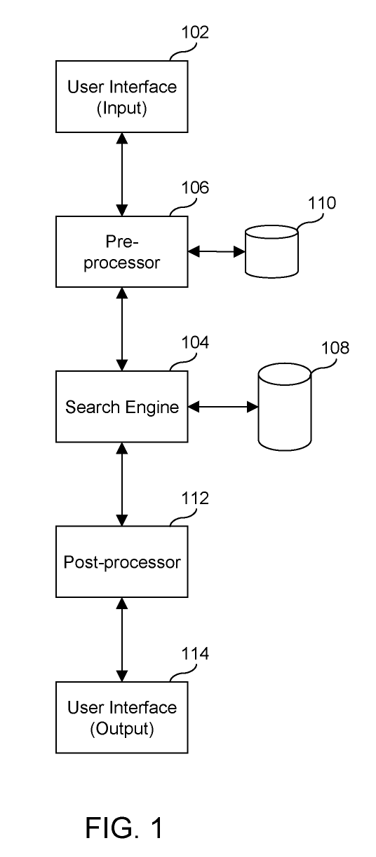

FIG. 1 is a schematic diagram illustrating the system elements, according to an embodiment of the invention. The diagram shows a user-interface 102 which serves as the means for interaction between a user and a search engine 104. According to an embodiment of the invention, search engine 104 may be any existing search engine, for example GOOGLE™ search engine, or YAHOO™ search engine. According to yet another embodiment of the invention, search engine may be any computer program module for searching a database, which runs at a server. The search engine server can be located either at a remote location on the World Wide Web or at the client's computer. According to an embodiment of the invention, a user enters a search query consisting of two or more search terms, wherein the search query has at least one of the search terms stylized. The user is allowed to enter the search terms in different stylistic patterns in an editable interface. Thus, a user can boldface, highlight, italicize, underline or change the font of the search terms to increase or decrease the priority of the search term. Here the priority of a search term indicates the degree of importance of the term with respect to other search terms in the search query. This degree of importance is specified by the user performing the search and may be different for different users. For example, a search query has three search terms say, ‘California’, ‘software’ and ‘companies’ and user stylizes the term ‘California’ such that ‘California’ is the most important of all the search terms. (It may be given highest priority by boldfacing it or increasing its font). Further, other methods of stylizing a search term may be used. According to an embodiment of the invention, a search term with strike-through may mean the search term should not exist in the search result set. For example, a search term specified as “Official” may mean the word “Official” should not exist in the result set at all. This is implemented by assigning weight-factors or weights to different stylistic patterns. Weights represent the numerical values assigned to different stylistic patterns. For example, a boldfaced word may have a weight of 1.5, while an italicized word may have a weight of 0.6. Higher numerical value of weight represents higher priority for the search term. According to one embodiment of the invention, the weights for various styles are defined by a user and are stored. According to yet another embodiment of the invention, the weights for various styles are pre-defined and stored at the server end. The search engine executes the search query and scores are assigned to search results based on the weights of the search terms. The search results are then re-arranged in a descending order of scores such that, the search results containing the more important search terms are placed before the other results. Thus, in the above example, the search results are arranged such that search results having ‘California’ are placed above other search results.

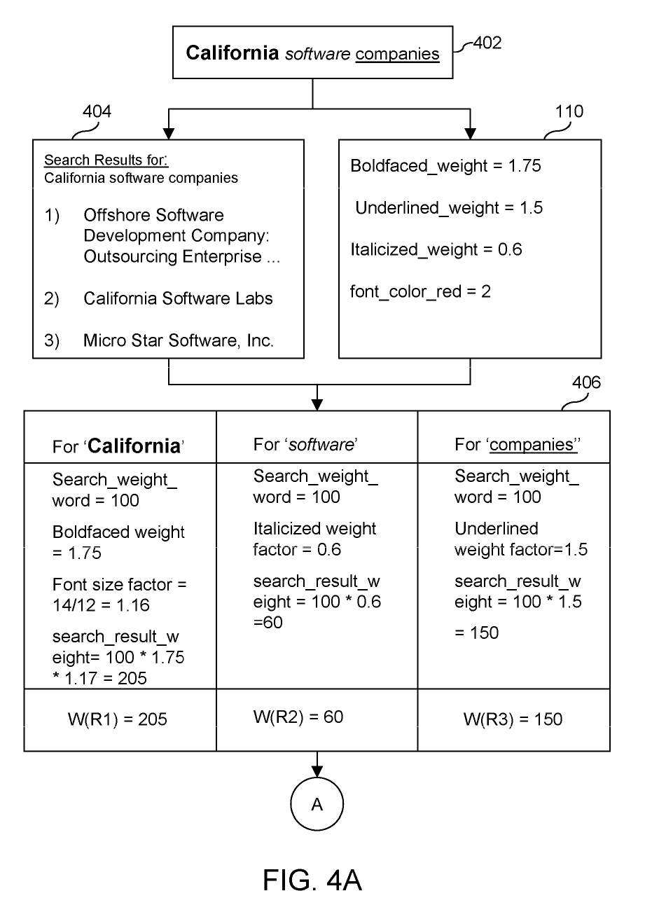

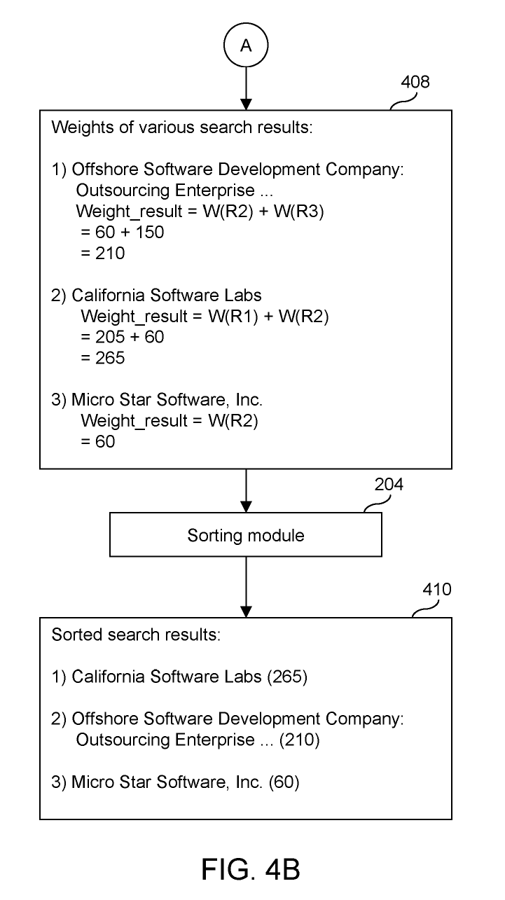

In an embodiment of the invention, a pre-processor 106 performs the initial function of parsing the search query into search terms. Pre-processor 106 also performs the function of assigning weights to each of the search terms. Pre-processor 106 communicates with a weight-storing module 110. Weight-storing module 110 stores the weights for different stylistic patterns. Weight-storing module 110 can also store various logic-conditions for different stylistic patterns and their combinations thereof. The logic-conditions are a set of rules defining the priority of a style over the other styles. The logic-conditions have been further explained in conjunction with FIGS. 4A and 4B. In one embodiment of the invention, weight-storing module 110 is a memory module located at the remote search engine server side. Weight-storing module 110 offers a way to store user preferences indicating weights and rules for various stylistic patterns. A user manually inputs weights for different stylistic patterns or attributes forming a pre-defined list of weights. This offers the user a choice to change the default values of the weights. These preferences can be accessed and changed by the user once she logs on to the search engine server. According to yet another embodiment of the invention, weight-storing module 114 may be present at the client's computer.

In an embodiment of the invention, pre-processor 106 is a microprocessor. Generally, commercially available microprocessors 106 from companies like AMD™, Intel™ and Motorola™ may be used. According to an embodiment of the invention, pre-processor 106 is located at the client's computer system. In an alternate embodiment, pre-processor 106 is located at the search engine server end.

After the weights have been determined in pre-processor 106, the search terms and their respective weights are presented to search engine 104. Further, search engine 104 has an access to a database 108. In the present invention, database 108 is any collection of information and contains several items. The items could be documents, files, folders, pictures, music or videos. Each of the items in the collection may be compared to the search query to determine whether the item matches the search query. The collection of information may be information on the Internet, a similar network having a collection of documents, or a private structured database or any other searchable entity. Such a database typically includes an index representing each item in the collection of information in order to simplify the search process. In some cases, such as with a search engine for the World Wide Web, or the Internet, the index is accessed by the search engine while the actual documents to be accessed using the results of a query is done from a remote source. The remote source is a database, which can be physically located at any location on the internet network.

Search engine 104 performs the search process in database 108 to provide search results. The search results provide an indication of the items in database 108 that match the search query. According to an embodiment of the invention, a post-processor 112 receives search results from search engine 104 and applies weights to each of the corresponding items in search results to obtain scored search results. The calculation and methodology of scoring search results has been explained in conjunction with FIGS. 4A and 4B.

According to yet another embodiment of the invention, the search results are dynamically displayed while database 108 is being searched. The search results are assigned weights and are sorted at the same time, allowing for the dynamic displaying of the search results and updating of the displayed search results.

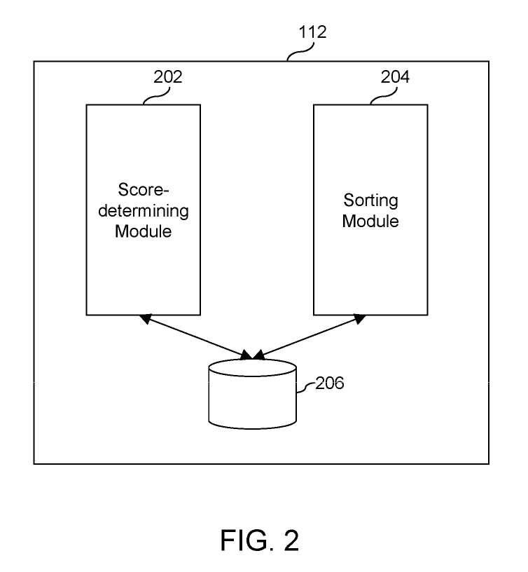

The scored search results are further, sorted by post-processor 112 in descending order of scores and then provided to a user-interface 114 to be provided as output to the user. Post-processor 112 is a processor cum memory module which has been explained in detail in conjunction with FIG. 2. The sorted results are then provided to user-interface 114 as an output to the user. It would be apparent to a person skilled in the art that one or more output devices may be connected to post-processor 112. Examples of output devices include a cathode ray tube (CRT) display, liquid crystal displays (LCD), printers, communication devices such as a modem, and audio output. It would be apparent to a person skilled in the art that the invention is not limited to any particular input or output devices used.

According to yet another embodiment of the invention, formatted images can be provided as search objects to user-interface 102. In images the basic information is stored in the pixel values of the image. Each image is a collection of pixels with individual specific values. Other ways of storing this information is vector graphics where mathematical equations govern the value of the pixel. When highlighting portions of images, the base value of the pixel is altered. When one or more portions of an image are selected, they are offset by a common value. A user can select more than one portion of the image and change the shading color and this has the effect of changing the offset by different values. These one or more shaded portions act as search objects. If the shading color is Green it can be used to signify more importance. Shading with red may signify ‘most important’. Numeric values can be assigned for each shade and these numeric values can be used to determine the priority of the search object.

When more than one portion is selected, the search engine searches for occurrence of shaded objects in other images in its search database. The ordering of the search results is based on the weights assigned to the selected portions. Pre-processor 106 parses different highlighted image objects and assign weights to each highlighted image object. After the weights have been determined in pre-processor 106, the highlighted image objects and their respective weights are presented to search engine 104. Further, search engine 104 has access to a database 108 to provide the search results matching the search query.

FIG. 2 is a schematic diagram representing post-processor 112, in an embodiment of the invention. Post processor 112 comprises a score-determining module 202 and a sorting module 204, both of which are connected to a storage device 206. Score-determining module 202 receives the search results as well as the weights of different search terms from search engine 104. The search results as well as the associated weights are stored in storage device 206. The weights are then assigned to various search items in score-determining module 102 to get the scores for each of the search result. A more detailed illustration of the score-assignment is discussed in conjunction with FIGS. 4A and 4B. Further, the results are sorted in descending order of scores in sorting module 204. According to an embodiment of the invention, the various processes in post-processor 112 namely, the score-determination and the sorting are performed by micro-processors, which are located at the remote search engine server side. In an alternate embodiment of the invention, the various processes in post-processor 112 are performed by micro-processors that are located at the client's computer side.

Pre-processor 110 and post-processor 112 may be embodied in the form of a processing machine. Typical examples of a processing machine include a computer, a programmed microprocessor, an integrated circuit, and other devices or arrangements of devices that are capable of implementing the steps of the method of the current invention.

The processing machine executes a set of instructions that are stored in one or more storage elements, in order to process input data. The storage elements may also hold data or other information as desired. The storage element may be in the form of an information destination or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the Internet or any client server models that enable communication. Such communication technologies may use various protocols such as TCP/IP, UDP, ATM or OSI.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claim.

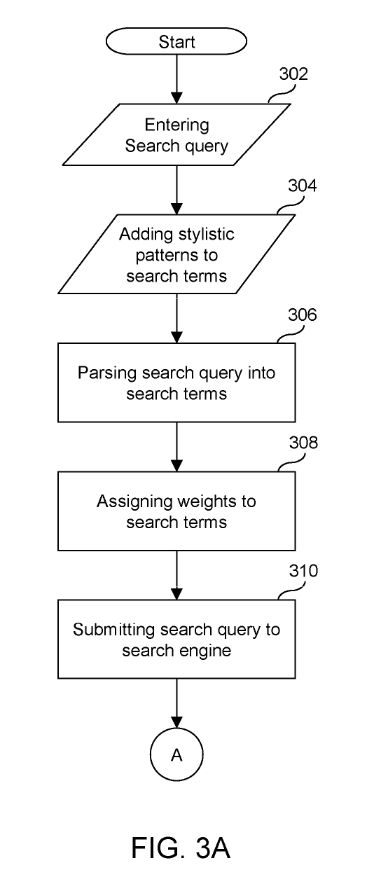

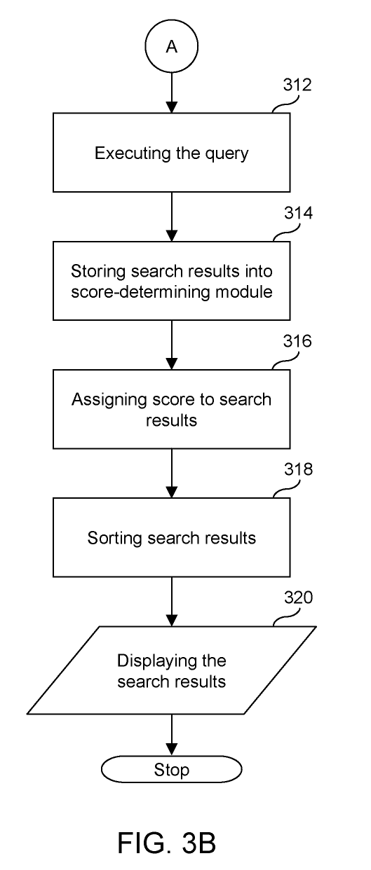

FIGS. 3A and 3B is a flowchart representing the process of re-organizing the searched results, in accordance with an embodiment of the invention. At step 302, two or more search terms are received from a user as a search query. The user enters the search query through user-interface 102. According to an embodiment of the invention, user-interface 102 is an editable interface on a computer system. This editable interface is programmed in a high-level language enabling the computer system to communicate with the user and with search engine 104. The editable interface presents to the user various options in form of tabs and buttons, for stylizing the search terms. At step 304, user adds stylistic patterns to at least one of the search terms. User may change the style of the search terms in various ways to change the priority of the words in the search query. This offers a visually intuitive method to vary the priority of the search terms in a search query such that each search term has a different weight than the others. In one embodiment, user boldfaces a search term, to increase its priority as compared to other search terms, italicizes a search term to decrease its priority with respect to other terms. For example, user enters ‘California software companies’ as a search query. Next, user boldfaces the search term ‘software’ and italicizes the search term ‘companies’. This in effect prioritizes ‘software’ to be the most important term while ‘companies’ will be the least important in the priority. In different embodiments of the invention, user may choose other stylistic patterns for the search terms. This may include increasing or decreasing the fonts of the search terms, changing the color of the font i.e. the search terms, changing the background color (thereby highlighting the search terms with different colors denoting different priority), underlining a search term or even choosing a combination of one or more styles. However, it would be apparent to a person skilled in the art that the present invention is not limited to above-mentioned stylistic patterns only. At step 306 pre-processor 106 parses the search query into search terms. For example if the search query is ‘California software companies’, pre-processor 106 parses the search query into first search term ‘California’, a second search term ‘software’ and a third search term ‘companies’. At step 308, pre-processor 106 the application program retrieves the weights for the search terms from weight-storing module 110 and assigns them to various search terms. At step 310, the search terms and the associated weights are submitted to search engine 104 via an API or Application Program Interface. Application program interface is a set of routines, protocols, and tools for building software applications. APIs facilitate the integration of user-interface 102 and search engine 104. According to an embodiment of the invention, the search terms and the associated weights are submitted to search engine 104 through Command Line parameters. Command line parameters are input parameters to computer commands issued at computer command line.

At step 312, search engine 104 executes the search query performing a search on database 108.

At step 314, search results returned by search engine 104 are received in score-determining module 202 and are stored in storage device 206. In an embodiment of the invention, storage device 206 is a memory module at the remote search engine server side. In an alternate embodiment of the invention storage device 206 is located in the random access memory of the client's computer. At step 316, weights for different search terms are assigned to the search items in score-determining module 202. A more detailed illustration of the score-assignment is discussed in conjunction with FIGS. 4A and 4B. At step 318, the scored search results are sorted in descending order of scores in sorting module 204. At step 320 the sorted results are provided to user-interface 114 to be output to the user.

FIGS. 4A and 4B illustrate the methodology for determining the scores of search results 402. For example, user provides “California software companies” as search query 402 through user-interface 102. User edits and increases the font of the search term ‘California’ from 12 to 14, and boldfaces the search term. ‘Software’ is italicized and the search term ‘companies’ is underlined as illustrated in FIG. 4A. Search query 402 is submitted to search engine 104, which performs a search on database 108. Score-determining module 202 receives the search results as well as the weights of different search terms from search engine 104. The search results as well as the associated weights are stored in storage device 206. According to an embodiment of the invention, score-determining module 202 obtained from the search, viz.

(1) Offshore Software Development Company:

(2) Outsourcing Enterprise;

(3) California Software Labs;

(4) Micro Star Software, Inc.

Further, weight-storing module 110 stores the weight factors for different stylistic patterns. For example, some of the user-defined weight factors as stored in weight-storing module 110 are:
Boldfaced_weight=1.75;
Underlined_weight=1.5;
Italicized_weight=0.6;
Font_color_red=2.

Block 406 illustrates weight calculation for each of the search term in accordance with an embodiment of the invention. By default, for each of the search term, the various weights (associated to different stylistic pattern) are, as one embodiment of the invention, multiplied by a fixed number to give a numerical weight for the search term. However, other logic conditions may be applied to vary the numerical values significantly so as to prioritize the search terms. An example of the logic condition may be that for a ‘boldfaced’ search term, the weight be raised exponentially (so as to significantly increase the emphasis with respect to other search terms) instead of multiplying the weight to a fixed value. However, it must be apparent to a person skilled in the art, that other logic-conditions can also be stored in weight-storing module 110.

According to an embodiment of the invention, the following variables are used for calculating the weight of each search term:
(1) search_result_weight: It is total weight of each search term, and is initialized to zero;
(2) search_word_weight: If the search term exists in the search result it is initialized to 100 else it is set to zero;
(3) boldfaced_weight: It is a numerical factor which is set by user for emphasizing a boldfaced word with respect to other words;
(4) underlined_weight: It is a numerical factor which is set by user for emphasizing an underlined word with respect to other words;
(5) italicized_weight: It is a numerical factor which is set by user for emphasizing an italicized word with respect to other words;
(6) font_color_red_weght: It is a numerical factor which is set by user for emphasizing font color of search term as red with respect to other words;
(7) background_color_weight: It is a numerical factor which is set by user for emphasizing background color of the search term as compared to other words;
(8) default_font_size: It is the default font size set for entering the search terms;
(9) new_font_size: It is the font size which the user sets for increasing or decreasing the importance of the word as compared to the default text size.
(10) Thus, the font size factor is given by: font size factor=new_font_size/default_font_size.

However, above mentioned variables are only illustrative and are in no way exhaustive. Other variables may be used for other choices.

In the illustrated example, for the term “California” which has two stylistic patterns—boldfacing and the increased font, the calculation methodology is as follows:
(1) If the term “California” exists in the search result then search_word_weight=100.
(2) Further, as defined by user, from weight-storing module 110,
(3) boldfaced_weight=1.75;
(4) Also, default_font_size=12;
(5) new_font_size=14;
(6) Therefore, Font size factor=14/12=1.16.
(7) Now, search_result_weight is given by different weights multiplied to the search_word_weight, i.e., search_result_weight=search_word_weight*boldfaced_weight*Font size factor=100*1.75*1.17=205.
(8) Therefore, W(R1)=205, where W(R1) denotes the search result weight for the first search term. Similarly, denoting W(R2) and W(R3) for the search result weights for the second and third search terms.

The above methodology is applied similarly to other search terms ‘software’ and ‘companies’ as shown in the block 406. The search result weights are W(R2)=60 and W(R3)=150 respectively. Once the search result weights of each of the search terms are determined, each of the search result stored in score-determining module 202 is then evaluated to find the total score of the search result. Here, each search result is seen for search terms. If in a particular search result a search term is present, corresponding word weight is added to the score of that search result. As illustrated in block 408, the first search result is:
“Offshore Software Development Company:
Outsourcing Enterprise.”
The search terms “software” and “companies” are present in the search result and hence the score of the first search result is =word weight for “software” and word weight for “companies”. (This has been illustrated in FIG. 3B)
score=W(R2)+W(R3)
=60+150
=210

Similarly, for other search results, the scores have been evaluated in block 408. These are:

For “California Software Labs”
Score=W(R1)+W(R2)
=205+60
=265

For “Micro Star Software, Inc.”.
Score=W(R2)
=60

The searched results are now sorted in descending order of scores in sorting module 204. The sorted results are provided to user-interface 114 to be output to the user (block 410).

In yet another embodiment of the invention, the search results are dynamically sorted while database 108 is being searched. The search results are assigned weights and are sorted at the same time. For example, as illustrated in the above instance, in reference to the three companies, search engine 104 will search database 108 and retrieves the first match as “Offshore Software Development Company Outsourcing Enterprise.”. The score of the search result is assigned as ‘210’ from the weights. Post-processor 112 checks if there are any existing search results in the buffered search result set with higher score. The search result “Offshore Software Development Company: Outsourcing Enterprise.” is then inserted into the buffer. Search engine 104 retrieves for example, “California Software Labs” as the next search result. Post-processor 112 assigns ‘265’ as score to the search result “California Software Labs” based on the weights of search terms “California” and “Software”. The position of the search result “California Software Labs” is compared with the existing displayed search results. Post-processor 112 compares the scores of the existing result set and the current search result. Thus, “California Software Labs” is placed before “Offshore Software Development Company Outsourcing Enterprise.” at number one position in the buffered result set. Search engine 104 then retrieves “Micro Star Software, Inc.” as the next search result. Post-processor 112 assigns ‘60’ as score to the search result. The comparison of the score of the current search with the buffered result set, positions “Micro Star Software, Inc.” at the third place. The buffered search results are then provided to user-interface 114 to be output to the user.

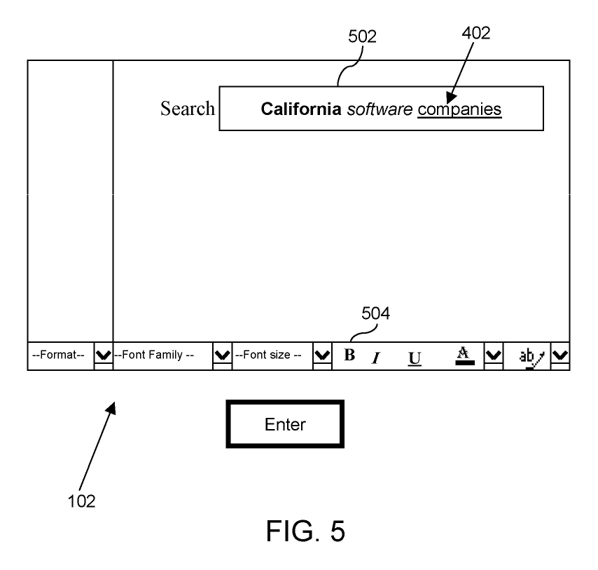

FIG. 5 illustrates an example user-interface 102 through which a user may input search query 402. User-interface 102 has a text box 502 to receive search query 402 and a toolbar 504 to the enable user to stylize the search terms.

Toolbar 504 has font size and font family drop-down buttons so as to enable the user to change the font size and change the font family of a search term. In different embodiments of the invention, user may choose to define different search terms in different fonts and set different weights for the same in weight-storing module 110. For example, ‘California’ may be written in “Times New Roman”, while user may choose to keep the search terms ‘software’ and ‘companies’ in “Arial” font. User may also define a weight-factor of 0.1 for “Times New Roman” font while 1.5 for “Arial” font, thereby assigning least priority to search terms entered in “Times New Roman”.

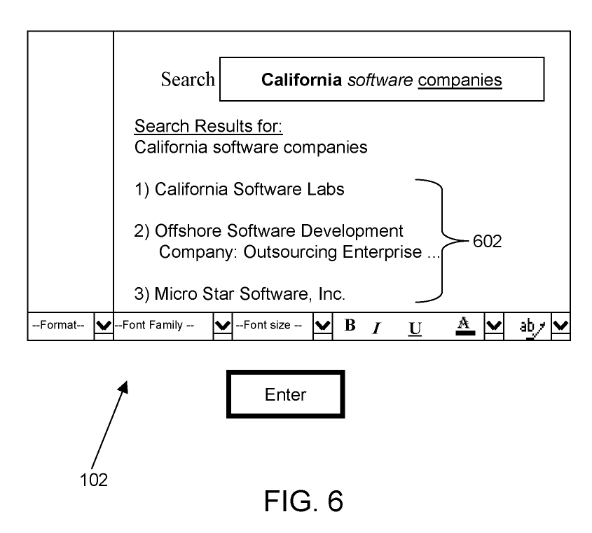

FIG. 6 illustrates a presentation of the list of searched items, in accordance with an embodiment of the invention. As shown user-interface 102 displays the search results 602 in a descending order of scores. The search results are arranged as per the importance assigned by the user to various search terms and are thus prioritized based on the user preference.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A computer implemented method for prioritizing search results based on weights of one or more search terms in a search query, the method comprising steps of:
(a) receiving two or more search terms from a user through a user interface, wherein at least one search term has a different stylistic pattern than the other search terms in the search query;
(b) performing a search based on the search terms through a search engine;
(c) storing the search results of the search in a post-processor;
(d) obtaining weights corresponding to different stylistic patterns from a predefined list of weights;
(e) determining the score of each search result in the post-processor based on the weights; and,
(f) prioritizing the search results based on the scores and presenting the prioritized search results to the user through an appropriate user interface.

2. The computer implemented method according to claim 1, wherein the step of receiving the search terms further comprises submitting the search query to the search engine.

3. The computer implemented method according to claim 1, wherein the predefined list of weights comprises of numerical factors assigned to each of the stylistic patterns.

4. The computer implemented method according to claim 1, wherein the predefined list of weights is defined by the user.

5. The computer implemented method according to claim 1, wherein the search results are prioritized in a specified order of scores.

6. The computer implemented method according to claim 1, wherein the prioritized search results are presented through an appropriate user interface.

7. A computer system for prioritizing search results based on weights of one or more search terms in a search query, wherein the search query has at least one of the search terms stylized, the system comprising:
(a) a user-interface, the user-interface receiving the search query;
(b) a pre-processor, the pre-processor storing weights and logic-conditions for different stylistic patterns;
(c) a search engine, the search engine finding search results based on the user query; and,
(d) a post-processor, the post-processor receiving search results from the search engine, and assigning scores to each of the search results based on weights and logic conditions and sorting the search results based on the scores.

8. The computer system as recited in claim 7, wherein the user-interface for presenting the prioritized search results is a computer screen.

9. The computer system as recited in claim 7, wherein the post-processor further comprises of a score-determining module, a sorting module and a storage device.

10. The computer system as recited in claim 7, wherein the pre-processor further comprises of a weight-storing module.

11. The computer system as recited in claim 7, wherein the pre-processor is located at the search engine server.

12. The computer system as recited in claim 7, wherein the post-processor is located at the search engine server.

13. A computer implemented method for prioritizing search results based on weights of one or more search objects, the method comprising steps of:
(a) receiving two or more search objects from a user through a user interface, wherein at least one search object has a different attribute than the other objects;
(b) performing a search based on the search objects;
(c) storing the search results of the search in a post-processor;
(d) obtaining weights corresponding to different attributes from a predefined list of weights;
(e) determining the score of each search result in the post-processor based on the weights; and,
(f) prioritizing the search results based on the scores and presenting the prioritized search results to the user through an appropriate user interface.

14. The computer implemented method according to claim 13, wherein the search object is a highlighted part of an image.

15. The computer implemented method according to claim 13, wherein the search object is a tagged part of a video file.

16. The computer implemented method according to claim 13, wherein the search object is a tagged part of an audio file.

17. The computer implemented method according to claim 13, wherein the search object is a highlighted part of a hologram.

18. The computer implemented method according to claim 13, wherein the search object is an emphasized part of a digital data.

19. The computer implemented method according to claim 13, wherein the step of receiving the search objects further comprises submitting the search objects to the search engine.

20. The computer implemented method according to claim 13, wherein the predefined list of weights comprises of numerical factors for each of the attributes associated with the search objects.

21. The computer implemented method according to claim 13, wherein the predefined list of weights is defined by the user.

22. The computer implemented method according to claim 13, wherein the search results are prioritized in a defined order of scores.

23. The computer implemented method according to claim 13, wherein the search results are presented to the user through an appropriate user interface.
